(19) United States
(12) Patent Application Publication
(10) Pub. No.: US 2004/0159609 A1
(43) Pub. Date: Aug. 19, 2004

(54) Nanofibers in cake filtration

(76) Inventor: George G. Chase, Wadsworth, OH (US)

Correspondence Address: RENNER, KENNER, GREIVE, BOBAK, TAYLOR & WEBER, FIRST NATIONAL TOWER FOURTH FLOOR, 106 S. MAIN STREET, AKRON, OH, 44308, US

(21) Appl. No.: 10/368,968

(22) Filed: Feb. 19, 2003

(51) Int. Cl. B01D 65/02

(52) U.S. Cl. 210/636; 210/650; 210/638

(57) ABSTRACT

The present invention provides a method for improving one or more of the operations of forming, washing, deliquoring, and collecting a filter cake. In this method, a slurry of at least one solid and at least one liquid is drawn through a filter medium having an upstream and a downstream side, such that at least a portion of the at least one solid is collected on the filter medium as a filter cake. To improve the process, at least one nanofiber of a length of at least about one meter is collected upstream of the filter medium at a position selected from the group consisting of (1) downstream of the filter cake, (2) dispersed throughout the filter cake, (3) upstream of the filter cake, and (4) any combination thereof.

### BACKGROUND OF THE INVENTION

The present invention generally relates to cake filtration processes and filter cakes, and, more particularly, relates the use of nanofibers in cake filtration processes.

Cake filtration is widely known, and is used in a wide range of industries to separate solid particles from liquids. In cake filtration, separation is achieved on the upside stream of a filter medium. Typically, a porous filter medium is housed in a housing, and a pressure differential is established, driving the liquid through the filter medium. The solid particles to be separated from the liquid are either larger than the pores in the filter medium or are caused to approach the filter medium in large numbers, such that they bridge over the pores, and, in either case, begin to collect thereon. Thus, in cake filtration, the filter medium only begins the filtration process, while successive layers of the particles deposit on top of preceding layers to form a cake.

With respect to the formation of a filter cake, it is desirable that the cake not blind or plug the filter medium. Blockage of the filter medium would result in an excessively high pressure drop across the filter medium, frustrating the filtration process. On the other hand, the pores of the filter medium should not be so large that excessive bleeding of fine particles is permitted. However, after a small amount of the filter cake has formed on the filter medium, bleeding usually stops, because fine particles are caught in the cake itself.

If it is the solids that are desired to be collected, the cake will typically have to be washed to remove any undesirable elements retained within the cake. Furthermore, the cake may have to be deliquored to reduce the moisture content of the filter cake.

If the filter cake is to be washed, the cake should not crack during the washing process, because cracking causes inefficient cake washing. More particularly, when attempting to wash a filter cake having cracks throughout, the wash liquid tends to push through the cake non-uniformly, tending to gravitate toward the cracks, because the cracks present paths of least resistance to the flow of the washing liquid. In a similar manner, the existence of cracks in the filter cake can prevent satisfactory deliquoring of the cake as well.

When washed and deliquored, the filter cake should easily separate from the filter medium; however, it will be appreciated that such is not always the case. Rather, many times, the filter cake will adhere to the filter medium, with the result that time must be spent on separating the filter medium from the filter cake. Additionally, the amount or mass of solid particles ultimately collected might thus be compromised.

The present invention proposes a process for facilitating the formation, washing, liquoring, and collection of filter cakes, through selective methods, helping to ensure that, in a cake filtration process, the cake (1) does not blind or plug the filter medium, (2) can be uniformly washed and/or deliquored, and (3) can be easily separated from the filter medium.

### SUMMARY OF THE INVENTION

In general, the present invention provides a method for improving one or more of the formation, washing, deliquoring, and collection of a filter cake. In this method, a slurry of at least one solid and at least one liquid is drawn through a filter medium having an upstream and a downstream side, such that at least a portion of the at least one solid is collected on the filter medium as a filter cake. To improve the process, at least one nanofiber of a length of at least about one meter is collected upstream of the filter medium at a position selected from the group consisting of (1) downstream of the filter cake, (2) dispersed throughout the filter cake, (3) upstream of the filter cake, and (4) any combination thereof.

When collected downstream of the filter cake, the at least one nanofiber that is collected may be considered as a pre-coat on the filter medium. This nanofiber may be selected so that it does not stick to the filter medium, and is removed with the filter cake. The nanofiber material may be selected such that the filter cake easily separates from the nanofiber layer that forms on the filter medium as a pre-coat. Alternatively, the nanofiber material may be selected such that the nanofiber pre-coat easily separates from the filter medium. Additionally, it is believed that the pre-coat nanofiber layer may aid in the washing and/or deliquoring of filter cakes.

When the at least one nanofiber is collected upstream of the filter cake, it may be considered as a post-coat layer on the filter cake. When collected in this manner, it is believed that the nanofibers will collect at the locations of the path of least resistance through the filter cake, i.e., at the cracks therein. As the cracks are filled with the nanofiber, the resistance to flow at those cracks will increase, until the fluid carrying the nanofiber will be forced to flow along other paths. In this manner, it is theorized that all of the cracks in a filter cake may be filled until the cake surface has a more uniform resistance to flow. This will greatly improve the washing efficiency, by forcing a wash liquid to flow uniformly through the cake and not channel through the cracks. It is also posited that the post-coat layer of nanofibers can aid in deliquoring, by acting as a membrane that causes a deformable cake to squeeze together under pressure and reduce its volume.

When the at least one nanofiber is collected as dispersed throughout the filter cake, it may be considered what is termed herein as a“body feed,” and, essentially, forms a part of the filter cake that is produced. The nanofibers would be completely mixed with the slurry that contains the cake particles to be filtered to form the cake, and the mixing and filtration are performed through a process and apparatus to be disclosed herein below. More particularly, because the nanofibers are at least about one meter in length, and, preferably, even significantly longer, the nanofibers will bridge many times over the pore spaces between the filter cake particles. This nanofiber network provides a structural matrix that holds the particles together and reduces cracking during the cake washing and/or deliquoring processes.

### DESCRIPTION OF THE DRAWINGS

FIG. 1 is a schematic side view of a mixing apparatus for use in accordance with the method of this invention;

FIG. 2 is a top plan view thereof;

FIG. 3 is a front schematic view thereof, depicting mixing of the nanofibers with the particulate matter of a slurry, with a current generated by a circulation assembly;

FIG. 4 is a cross-sectional view of the collection chamber of the apparatus of FIGS. 1-3;

FIG. 5 is a schematic side view of the apparatus of FIG. 1, as employed to introduce nanofibers as a pre-coat on a filter medium;

FIG. 6 is a schematic side view of the apparatus of FIG. 1, depicting the introduction of nanofibers as a post-coat on a filter cake;

FIG. 7 is a schematic side view of an alternative apparatus; and

FIG. 8 is a cross-sectional view of the alternative apparatus of FIG. 7.

### PREFERRED EMBODIMENT FOR CARRYING OUT THE INVENTION

The present invention provides improvements in cake filtration processes, through the introduction of nanofibers in one or more stages of a cake filtration process. Typically, in cake filtration processes, a slurry of at least one particulate in a carrier fluid is forced, by a pressure differential, across a filter membrane, and, while the carrier fluid passes through the filter membrane, the solid particulates begin to collect on the upstream side of the filter medium, thus forming a “cake.” Herein, the process is improved, as summarized above, by introducing nanofibers to this general process. More particularly, nanofibers may be introduced as a pre-coat on the filter medium; as a body-feed, wherein the nanofibers are dispersed throughout the matrix of the solid particulates in the slurry and are dispersed throughout the filter cake upon its formation; as a post-coat on a formed filter cake; or any combination of the foregoing. Each addition, pre-coat, body feed, and post-coat, provides unique benefits. However, the general method for introducing nanofibers is similar for each type of addition. As the body feed method involves the most processing ingredients and is, perhaps, the most complicated process, it is treated first, with the somewhat more simplified pre-coat and post-coat methods being disclosed thereafter.

As used herein, a “slurry” is to be understood as referring to a mixture of at least one solid particulate in a liquid carrier fluid. “At least one solid particulate” is to be understood as referring to any type of solid particle that might be collected as a filter cake and may include, by way of non-limiting example, sewage sledge, chemical precipitates, biological products and mineral ores, and the like. Specific, non-limiting examples might include water treatment sludge, clays, algae, calcium carbonate, and titanium dioxide powder. A “carrier fluid” is a liquid that carries, typically as a suspension, the at least one solid particulate, and is generally removed in a cake filtration process to collect and purify the at least one solid particulate. As used herein a “nanofiber” refers to a fiber having a nano-scale dimension in width or diameter only, because, as will be appreciated herein, the present invention contemplates employing relatively long nanofibers.

The various apparatus embodiments described below should be capable of mixing nanofibers with virtually any slurry of at least one solid particulate in a carrier fluid. Further, the apparatus embodiments are capable of receiving manufactured, synthetic, and natural nanofibers. It will be understood that, to accommodate different fibers, it may be necessary to vary the operating conditions of the apparatus. For example, the density, pH, temperature, pressure, or other operating conditions of the process may be altered, as necessary. If desirable, the fibers may be treated by mechanical, electrical, or chemical means, prior to being introduced according to the operation of the apparatus. For example, the surface of the fibers might be electrically charged, functional groups might be added to the fibers, or the fiber might be hardened or set, with any or all of these exemplary fiber treatments serving to improve the mechanical or chemical stability that the fiber has with the slurry or cake.

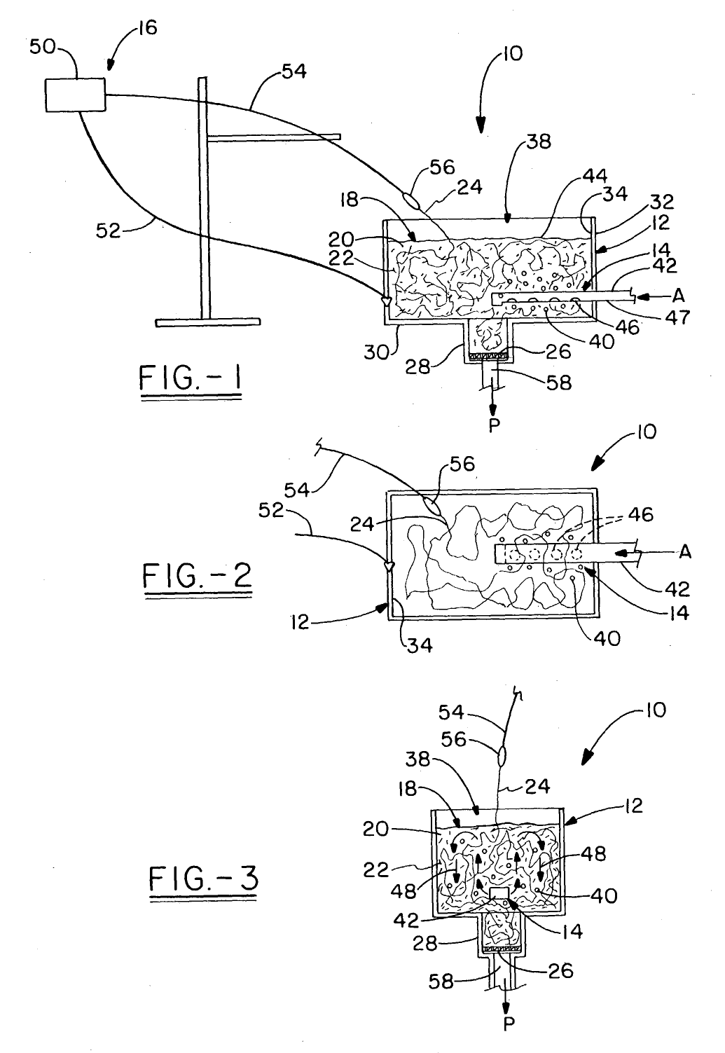

To provide the nanofibers as part of the filter cake, i.e., as a body feed, as described above, the present invention includes a mixing and filtration apparatus referred to generally by the numeral 10, in FIGS. 1-3. In general, the mixing and filtration apparatus 10 includes a filtration assembly 12, a circulation assembly 14, and a nanofiber delivery assembly 16.

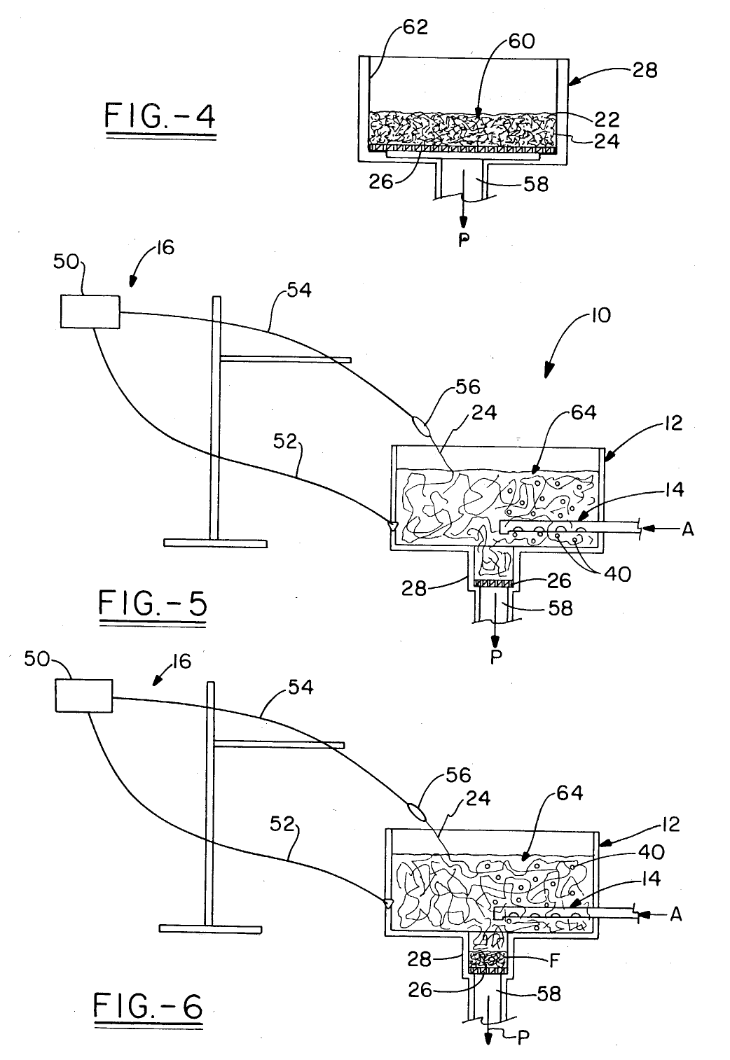

A slurry 18 of carrier fluid 20 and at least one solid particulate 22 is introduced to filtration assembly 12, where it is agitated by circulation assembly 14 to mix nanofibers 24 throughout the slurry 18. The nanofibers 24 are introduced via nanofiber delivery assembly 16. After the desired amount of nanofiber 24 is introduced, a vacuum (arrow P) is applied to draw slurry 18, now mixed with nanofiber 24, toward filter medium 26, which is held within a collection chamber 28. With reference to FIG. 4, filter medium 26 allows for the passage of carrier fluid 20, but blocks passage of solid particulates 22 and nanofiber 24 dispersed in slurry 18, such that a composite filter cake 60 (not shown in FIGS. 1-3) of nanofibers 24 and solid particulates 22 is formed on the upstream side of filter medium 26.

Filtration assembly 12 may be of any shape, size, or configuration, and, thus, is described in general terms. This being said, it will be appreciated that the size, shape, or configuration of filtration assembly 12 may be optimized to affect a satisfactory mixing of the nanofiber 24 with the slurry 18. Filtration assembly 12 includes floor 30 and at least one sidewall 32 extending upwardly therefrom to define cavity 34, in which slurry 18 may be received. As necessary, filtration assembly 12 may be provided with a lid or shield (not shown) to keep fluids within the container. Filtration assembly 12 is provided with at least one opening 38 to receive nanofibers, as described more completely below. As shown in FIGS. 1 and 3, opening 38 may simply be the open end of filtration assembly 12. As the method of fiber delivery requires, openings may be provided in floor 30, sidewall 32, or in a lid to receive nanofibers 24 within filtration assembly 12.

For the mixing process, slurry 18, including carrier fluid 20 and at least one particulate solid 22 is received in filtration assembly 12. Circulation assembly 14 is used to create a mixing motion within filtration assembly 12. As best shown in FIG. 1, circulation assembly 14 provides an agitation fluid, represented by bubbles 40, into slurry 18, to affect the mixing motion. Agitation fluid 40 is preferably gaseous, such that, upon its introduction to slurry 18, it rises to the top, creating a current, and escapes at opening 38. This gaseous agitation fluid 40 is introduced to filtration assembly 12 from a suitable source. It will be appreciated, however, that liquids of sufficiently less density than the carrier fluid 20 might alternatively be employed, wherein the liquid agitation fluid 40 would rise to the top of slurry 18, thereby generating a current, and overflow into an appropriately designed recirculation assembly that would recycle the overflowing fluid 40 back to the circulation assembly 14.

In one representative embodiment fluid 20 of slurry 18 is water, and agitation fluid 40 is air, its introduction being represented in FIG. 1 by the letter A. In this particular embodiment, air A would bubble upwardly through water 20, as it is delivered. As will be readily understood, in delivering agitation fluid 40 to filtration assembly 12, agitation fluid 40 may be pumped or delivered from a pressurized source. A variety of fluid delivery means may be used to accomplish the generation of currents within slurry 18, as will be described below.

In the representative circulation assembly 14 depicted in FIGS. 1-3, circulation assembly 14 includes wand 42, which enters filtration assembly 12 below surface 44 of slurry 18. Wand 42 contains at least one opening 46, for delivering agitation fluid 40 into slurry 18. Opening 46 is formed on lower surface 48 of wand 42. So situated, the incoming agitation fluid 40 bubbles out of the bottom of wand 42 and flows upwardly on either side thereof, setting up a substantially U-shaped flow or current, represented by arrows 48, in FIG. 3. Wand 42 may be placed generally centrally within filter assembly 12, allowing current 48 to fully develop on either side of wand 42. Currents 48 draw nanofibers 24 downwardly into the solid particulate matrix within slurry 18 to affect mixing of the at least one solid particulate 22 and the nanofibers 24.

Other or additional circulation assemblies 14 may be employed to generate a mixing motion within filter assembly 12. In its most basic form, circulation assembly 14 is an opening through which agitation fluid 40 enters slurry 18 to set up a current, such as current 48. Circulation assembly 14 may incorporate multiple openings randomly scattered or arranged in patterns along the inside surface of filter assembly 12 To achieve different flow characteristics for agitation fluid 40, circulation assembly 14 may incorporate a nozzle. Also, other implements, similar to wand 42, may be placed into or inserted through filter assembly 12, to the same effect.

Nanofibers 24 are delivered into filter assembly 12 in any known manner, including blowing, gravity feed, fluid jet, or electrospinning. The preferred method is electrospinning because it allows the nanofiber to be introduced as it is created, and, additionally, allows for the nearly simultaneous creation and introduction of significantly long fibers. Electrospinning processes are well known, and generally include an electrode that charges a solution to be drawn out into nanofibers and an electrode to charge the material to which the nanofiber solution is to be drawn. More particularly, the nanofiber solution is supplied in a syringe or pipette and is charged opposite of the material to which it is to be drawn, such that the nanofiber solution is pulled from the pipette to the surface of that oppositely-charged material, and, as it is being drawn out, the nanofiber solution forms at least one fiber that has a diameter or width of nanoscale.

Thus, as shown in FIGS. 1-3, nanofiber delivery assembly 16 preferably includes an eletrospinning device 50. Electrospinning device 50 includes first electrode 52, placed in electrical contact with slurry 18, to charge the same, and second electrode 54, suspended over surface 44 of slurry 18, and charging a nanofiber solution held within pipette or syringe 56. Slurry 18 is provided with a charge that is opposite the charge provided to the nanofiber solution, such that nanofibers 24 are created by electrical forces acting on the nanofiber solution introduced through pipette 56. The charge differential between the nanofiber solution and the slurry 18 forces the nanofiber solution to be drawn from pipette 56 to the surface 44 of slurry 18, where the nanofibers 24 thus created are acted upon by the motion of the current 48 in slurry 18, and are drawn therein to mix throughout the matrix of the at least one particulate solid 22 in slurry 18.

With reference to FIGS. 1 and 3, and with particular reference to FIG. 4, it can be seen that once the desired amount of nanofiber 24 is mixed throughout slurry 18, the mixture may be drawn, through a pressure differential represented by arrow P, toward collection chamber 28, which retains filter medium 26, blocking outlet 58. Filter medium 26 is selected such that carrier fluid 20 may pass therethrough, under the influence of pressure differential P, while solid particulates 22 and nanofibers 24 form a filter cake 60 in collection chamber 28, on top of filter medium 26. The shape of filter cake 60 would depend upon the internal dimensions of collection chamber 28, as represented generally by the numeral 62.

When introduced as a body feed, and collected as part of a filter cake 60, nanofibers 24 bridge the pore spaces between solid particulates 22 of the filter cake 60 and form a network that provides a structural matrix that holds solid particulates 22 together, thereby reducing the tendency to crack during the cake washing and/or deliquoring process. Preferably, nanofibers 24, while being of nanoscale in width or diameter, are at least one meter long. It should be appreciated that, through the electrospinning process for forming nanofibers 24, it is possible to create nanofibers that are many kilometers in length, and should further be appreciated that such longer nanofibers would be even more desirable as a body feed for keeping the solid particulates 22 of a filter cake 60 together in a cake with high structural integrity. Thus, while it is preferred that nanofibers 24 be at least one meter in length, it is even more preferred that they be at least tens, hundreds, or thousands of meters in length. It should also be appreciated that, given the nanoscale cross-section of nanofibers according to this invention, it is possible to create many kilometers of nanofibers per gram of nanofiber solution. In body fed applications, the nanofiber is preferably present in an amount ranging from about 100 to 10,000 grams of nanofiber per cubic meter of filter cake volume, more preferably from about 2000 to 8000 grams, and, even more preferably, from 5000 to 7000 grams per cubic meter.

Regarding “nanofiber solutions” it will be appreciated that virtually any material capable of being electrospun might be employed to create and introduce nanofibers according to the particularly preferred invention disclosed herein. Non-limiting examples of materials that might be provided in solution to be electrospun into nanofibers include organic polymers, such as nylons, polyamide, polyimides, and polycarbonates. Processes might also provide useful nanofibers from non-organic polymers such as silanes and metal oxides. It is also contemplated that long carbon nanofibers might be produced and employed. These latter two groups may or may not be capable of being electrospun, but it will be recalled that this invention is not limited to the introduction of nanofibers through electrospinning.

Having disclosed above the method for the employment of nanofibers as a body feed in a cake filtration process, the application of nanofibers as pre-coats on a filter medium or as post-coats on a filter cake will be considered. Basically, in both applications, pre-coat or post-coat, the same process is employed as above; however, the filtration assembly, in the process, such as filtration assembly 12, simply contains a fluid, and not a slurry of carrier fluid and solid particulates. Additionally, the pre-coat process is carried out before a filter cake is formed in a collection chamber, while the post-coat process is performed after a filter cake has been formed in the collection chamber.

With reference to FIG. 5, it can be seen that, when employing nanofibers as a pre-coat on a filter medium, the same apparatus as disclosed with respect to FIGS. 1-4 may be employed, and, where applicable, the same numeric designations have been employed for the same component parts of the apparatus. In distinguishing between the body-feed application and the pre-coat application of nanofibers, slurry 18 of FIGS. 1-4, with carrier fluid 20 and solid particulates 22, is replaced simply with fluid 62. Thus, nanofiber 24 is spun into charged fluid 62, instead of a charged slurry 18. Circulation assembly 14 still agitates fluid 62, thereby mixing nanofiber 24 throughout the volume of fluid 62, as represented by the continuous nanofiber 24 randomly mixed throughout fluid 62, in FIG. 5. Pressure differential P then draws the combination fluid 62 and nanofiber 24 down to collection chamber 28, where fluid 62 passes through filter medium 26, while nanofiber 24 collects on top of filter medium 26. In this manner, a pre-coat of nanofibers 24 is provided on filter medium 26.

Pre-coating with nanofibers is useful because a small amount of nanofiber per unit area in a pre-coat layer acts like a membrane with a higher resistance to flow than the filter medium itself. It is believed that this higher resistance to flow will aid in the deliquoring of a filter cake subsequently formed on top of the pre-coated filter medium, either with or without body-feed nanofibers. It will be generally appreciated that, in the prior art, it sometimes occurs that, in deliquoring filter cakes, the applied air pressure will push through the cake nonuniformly. With a pre-coat of nanofibers on the filter medium, it is theorized that, when the air reaches the nanofiber layer, the small pores between the nanofibers will tend to stay wetted, due to capillary forces and surface tension, thus forcing the air pressure to move the liquid from other parts of the cake. Thus, by matching the wetting or nonwetting properties of the nanofibers with the wash liquid, the resistance to fluid flow, at the nanofiber layer, should be more controllable. After the cake is deliquored, the nanofiber layer can serve to aid in separating the cake from the membrane, simply by having chosen the nanofiber material such that the filter cake material does not readily stick thereto. Similarly, the nanofiber material may be selected so the nanofiber layer does not stick to the filter medium, and is removed with the filter cake.

In pre-coat applications, the nanofiber is preferably present in an amount ranging from about 10 milligrams to about 100 grams of nanofiber per square meter of the filter medium, more preferably from about 10 grams to 90 grams, and, even more preferably, from about 20 to about 70 grams per square meter.

With reference to FIG. 6, the process for creating a post-coat layer on a filter cake is disclosed. Notably, as with the disclosure relating to pre-coats, the apparatus of FIG. 1 is employed, with like parts in the process and apparatus receiving like numerals. However, in FIG. 6, it will be noted that collection chamber 28 includes a filter cake F, which may be formed by conventional techniques or with the pre-coat and/or body-feed nanofiber applications disclosed above. Additionally, as with FIG. 5, slurry 18 is replaced with fluid 62.

In the post-coat process, a filter cake F is formed in a collection chamber 28. Thereafter, a fluid 62 is introduced to filtration assembly 12, and agitated by circulation assembly 14. Nanofibers 24 are spun onto the surface of fluid 62, where they are mixed throughout fluid 62 by circulation assembly 14. Once the desired amount of nanofiber 24 has been introduced to fluid 62, pressure differential P is applied, drawing fluid 62 and nanofiber 24 to collection chamber 28, through filter cake F and filter medium 26. Nanofiber 24 thus collects on the upper surface of filter cake F.

The post-coat layer is similar to the pre-coat layer, except that it is applied to the surface of the filter cake, just prior to or during the washing cycle. The nanofibers are so small that they are easily carried by the fluid 62 to the surface of the cake. It is hypothesized that the nanofibers will tend to collect at the locations of least resistance to fluid flow (i.e., the cracks in the filter cake). Further, as the cracks are filled in with nanofiber, the resistance to flow will increase in that area, forcing the fluid to flow along other paths. This will generally occur until all of the cracks are filled in and the cake surface has a uniform resistance to flow. This process will improve the washing efficiency, by forcing the fluid to uniformly flow throughout the cake surface, and not channel through the cracks in the filter cake. Furthermore, the post-coat layer of nanofibers may aid in deliquoring, by acting as a squeezing membrane to cause a deformable cake to squeeze together and reduce its volume.

The nanofiber should preferably be flexible so that it is capable of bending and conforming to the crack opening. The nanofiber should also be chosen according to its chemical and physical compatibility with the cake and slurry, and should additionally be selected based upon the temperature of the operation.

In post-coat applications, the nanofiber is preferably present in an amount ranging from about 10 milligrams to about 100 grams of nanofiber per square meter of filter of the filter medium, more preferably from about 10 grams to 90 grams, and, even more preferably, from about 20 to about 70 grams per square meter.

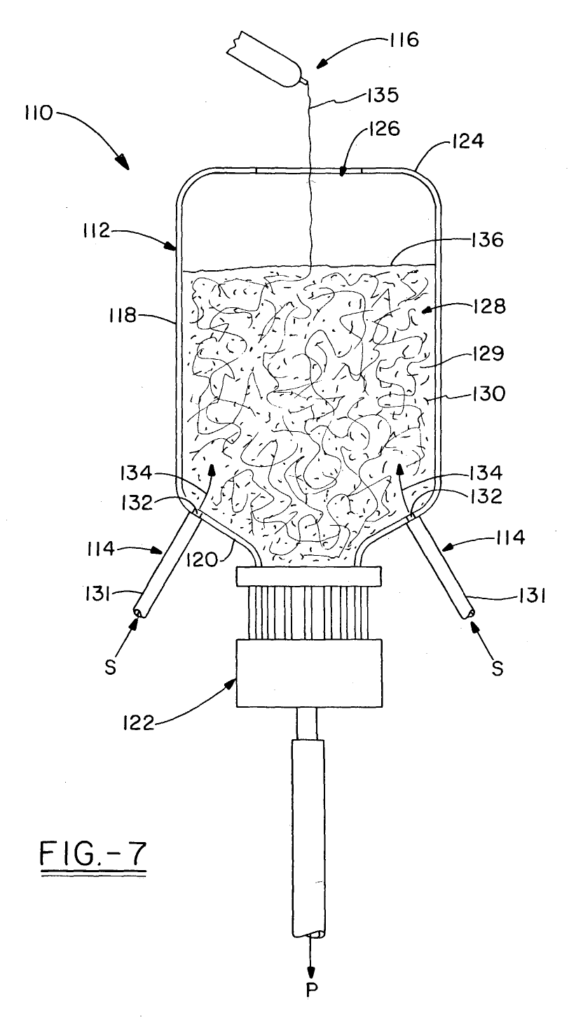

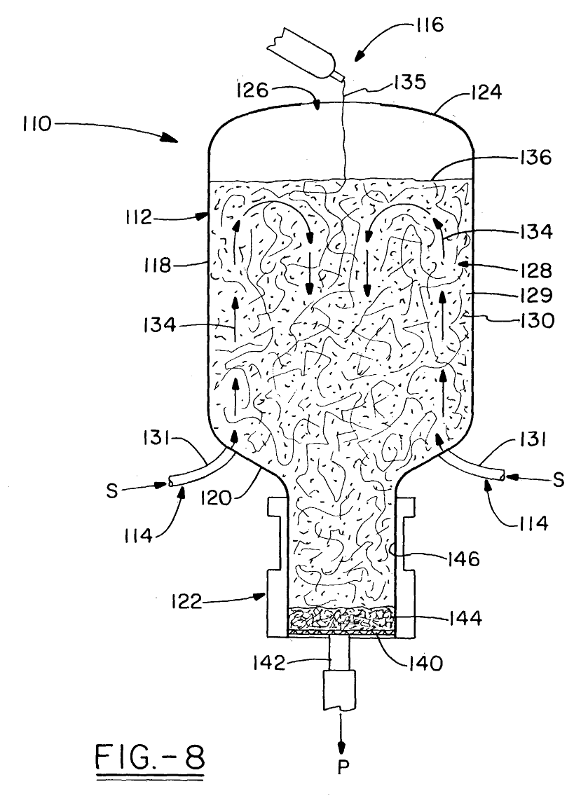

Having disclosed an apparatus and method for each of the pre-coat, body feed, and post-coat applications of nanofibers in cake filtration, an alternative mixing apparatus is now disclosed, with the understanding, from the disclosure herein above, that this apparatus may be employed to apply nanofibers in any or all three of these applications. Referring now to FIGS. 7 and 8, an alternative mixing apparatus 110 is disclosed. As with the embodiment of FIGS. 1-4, the body feed method is focused upon, with the understanding that means for practicing post-coats and pre-coats will be readily apparent.

Apparatus 110 is substantially similar to apparatus 10, and includes a filtration assembly 112, a circulation assembly 114, and a fiber delivery assembly 116. As shown in FIGS. 7 and 8, filtration assembly 112 has a generally cylindrical sidewall 118 extending upwardly from floor 120. Floor 120 extends downwardly toward a collection chamber 122. In the embodiment shown, collection chamber 122 extends centrally from floor 120, but may be located at any convenient point on filtration assembly 114. Floor 120 is preferably sloped in the direction of collection chamber 122, to facilitate drainage.

A splash shield 124 may be formed at the top of filtration assembly 112. In the embodiment shown, shield 124 is an integral portion of filtration assembly 112, extending upwardly and inwardly from sidewall 118, in an arcuate fashion. It will be appreciated that shield 124 may take on other forms, such as an angular extension, or a separate shield 124 may be fastened or removably attached to filtration assembly 112. An opening 126 is formed centrally within shield 124, permitting access to an open end of filtration assembly 112.

Circulation assembly 114 is provided to agitate slurry 128, which, as above, includes carrier fluid 129 and solid particulates 130. In contrast to wand 42 of circulation assembly 14, which extends into filtration assembly 12 and has a plurality of openings 46 for generating current, circulation assembly 114 includes at least one wand 131 (two wands are shown in FIGS. 7 and 8) that mates with openings 132 located in floor 120. In the embodiment shown, two openings 132 are radially spaced proximate sidewall 118. Wands 131 introduce agitation fluid, from a suitable source represented by arrows S, into filtration assembly 112, through openings 132, directing the agitation fluid upwardly from floor 120. The agitation fluid may be channeled separately to each opening 132 or may be delivered to all of the openings 132 through a manifold. The agitation fluid is delivered with sufficient pressure to develop a current 134 within slurry 128. This current 134 sets up a mixing motion substantially as described above with respect to the embodiment of FIGS. 1-6, to mix nanofibers 135 throughout slurry 128.

Openings 132 are located in floor 120 near sidewall 118, and are aimed generally parallel to sidewall 118. In this way, agitation fluid entering filtration assembly 112 develops a current 134 that is initially parallel to sidewall 118. As the current reaches surface 136 of slurry 128, current 134 is directed inwardly toward the center of filtration assembly 112. At this point, current 134 curls downwardly toward floor 120. FIG. 8 depicts a schematic cross-section of filtration assembly 112, with current 134 more fully represented. It will be appreciated that the agitation fluid is gas and, thus, escapes at surface 136. In general, current 134 agitates slurry 128 to cause dispersion of nanofibers 135 throughout slurry 128, particularly throughout the matrix of solid particulates 130 dispersed throughout the carrier fluid 129 of slurry 128.

As previously described, nanofibers 135 are generally provided into filtration assembly 112 by a nanofiber delivery assembly 116. Nanofibers 135 may be introduced in any known manner, including blowing, gravity feed, fluid jet, or electrospinning, with electrospinning techniques being preferred. Having already described the electrospinning nanofiber delivery assembly 16 of FIGS. 1-6, it should be appreciated that nanofiber delivery assembly 116 would operate in a substantially identical manner, such that nanofiber delivering assembly 116 is depicted schematically and referred to generally with respect to the embodiment of FIGS. 7 and 8. Once nanofibers 135 are throughly mixed throughout slurry 128, the formation of a filter cake, with nanofibers 135 within the cake as a body feed, may be carried out at collection chamber 122. The mixture of nanofiber 135 and slurry 128 is drawn toward collection chamber 122, through a pressure differential represented by arrow P in FIGS. 7 and 8. Collection chamber 122 retains filter medium 140, blocking outlet 142, through which the pressure differential P is applied. Filter medium 140 is selected such that carrier fluid 129 may pass therethrough, under the influence of pressure differential P, while solid particulates 130 and nanofibers 135 form a filter cake 144 in collection chamber 122, on top of filter medium 140. The shape of filter cake 144 depends upon the internal dimensions of collection chamber 122, as represented generally by the numeral 146.

Thus, an alternative apparatus 110 for introducing nanofibers 135 as part of a body feed in a filter cake 144 to be created is generally disclosed. It will be appreciated that the pre-coat and post-coat applications of nanofibers 135 could easily be practiced with apparatus 110, in light of the disclosure hereinabove with respect to pre-coats and post-coats of nanofibers.

The disclosure herein, regarding preferred embodiments, is mainly concerned with lab scale filtration as well. It will be appreciated that, in industrial scale operations, the apparatus holding the slurry is typically separate from the apparatus wherein the filer cake is formed. Thus, with industrial scale applications, it is envisioned the slurry would be prepared in a separate tank, and then fed by gravity, pushed by air pressure, or pumped by centrifugal pump into a filter press, centrifugal filter, pressure filter, crossflow filter, or the like. The nanofiber would be added to the slurry tank, and would advance with the slurry to the filter that is employed. Ideally, the nanofibers should not pass through a pump, although a pump would typically be used to advance the slurry to the filter. The pump could be located upstream of the slurry tank to “push” the slurry into the filter, or the slurry tank could be pressurized with air pressure to push the slurry through the filter. Also, the pump could be located downstream of the filter to “pull” the slurry through the filter.

In light of the foregoing, it should thus be evident that the process of the present invention, providing nanofibers in a cake filtration, substantially improves the art. While, in accordance with the patent statutes, only the preferred embodiments of the present invention have been described in detail hereinabove, the present invention is not to be limited thereto or thereby. Rather, the scope of the invention shall include all modifications and variations that fall within the scope of the attached claims.

What is claimed is:

1. A method for improving at least one of either the creation, deliquoring, or washing of a filter cake comprising the steps of:
drawing a slurry of at least one solid and at least one liquid through a filter medium having an upstream and downstream side, such that at least a portion of the at least one solid is collected on the filter medium as a filter cake; and
collecting at least one nanofiber of a length of at least about 1 meter upstream of the filter medium and downstream of the filter cake.

2. The method of claim 1, further comprising the step of adding the at least one nanofiber to a carrier fluid and collecting said at least one nanofiber on the upstream side of said filter, before said step of drawing a slurry through the filter medium.

3. The method of claim 2, wherein the at least one nanofiber is selected according to an ability to be released from the filter cake.

4. The method of claim 2, wherein the at least one nanofiber is selected according to an ability to be released from the filter membrane.

5. The method of claim 2, wherein the at least one nanofiber is selected according to an ability to chemically attract particles of the at least one solid.

6. The method of claim 2, wherein said step of adding the at least one nanofiber to a carrier fluid includes introducing an agitation fluid into said carrier fluid to cause a dispersal of said at least one nanofiber throughout said carrier fluid.

7. The method of claim 6, wherein said step of adding the at least one nanofiber to a carrier fluid includes electrospinning the at least one nanofiber into the carrier fluid.

8. A method for improving at least one of either the creation, deliquoring, or washing of a filter cake comprising the steps of:
drawing a slurry of at least one solid and at least one liquid through a filter medium having an upstream and downstream side, such that at least a portion of the at least one solid is collected on the filter medium as a filter cake; and
collecting at least one nanofiber of a length of at least about 1 meter upstream of the filter medium and upstream of the filter cake.

9. The method of claim 8, further comprising the step of adding the at least one nanofiber to a fluid selected from:
(a) a final fraction of the at least one liquid of said slurry being drawn through the filter medium, the final fraction being on the upstream side of the filter medium, and
(b) a wash fluid introduced upstream of the filter medium, after substantial formation of the filter cake, such that the at least one nanofiber is collected substantially upstream of the filter cake as a post-coat on the filter cake.

10. The method of claim 9, said step of adding the at least one nanofiber to a fluid selected from the group consisting of (a) and (b) includes introducing an agitation fluid into the fluid (a) or (b) to cause a dispersal of said at least one nanofiber throughout said fluid (a) or (b).

11. The method of claim 10, wherein said step of adding the at least one nanofiber to a fluid selected from the group consisting of (a) and (b) includes electrospinning the at least one nanofiber into the fluid (a) or (b).

12. A method for improving at least one of either the creation, deliquoring, or washing of a filter cake comprising the steps of:
drawing a slurry of at least one solid particulate and at least one liquid through a filter medium having an upstream and downstream side, such that at least a portion of the at least one solid particulate is collected on the filter medium as a filter cake; and
collecting at least one nanofiber upstream of the filter medium and downstream of the filter cake, wherein the at least one nanofiber is sufficiently long to bridge the pore spaces of the filter medium.

13. A method for improving at least one of either the creation, deliquoring, or washing of a filter cake comprising the steps of:
drawing a slurry of at least one solid particulate and at least one liquid through a filter medium having an upstream and downstream side, such that at least a portion of the at least one solid particulate is collected on the filter medium as a filter cake; and
collecting at least one nanofiber upstream of the filter medium and upstream of the filter cake, wherein the at least one nanofiber is sufficiently long to bridge pore spaces on the surface of the filter cake.
